(19) United States
(12) Patent Application Publication
(10) Pub. No.: US 2022/0036465 A1
(43) Pub. Date: Feb. 3, 2022

(54) SYSTEMS AND METHODS FOR DECENTRALIZING VEHICLE REGISTRATION USING BLOCKCHAIN

(71) Applicant: State Farm Mutual Automobile Insurance Company, Bloomington, IL (US)

(72) Inventors: Brian Fields, Phoenix, AZ (US); Heath Crossland, Phoenix, AZ (US)

(21) Appl. No.: 16/672,058

(22) Filed: Nov. 1, 2019

Related U.S. Application Data
(60) Provisional application No. 62/866,995, filed on Jun. 26, 2019.
(60) Provisional application No. 62/827,507, filed on Apr. 1, 2019.

(51) Int. Cl. G06Q 40/08; G06F 16/27; H04L 9/32

(52) U.S. Cl. CPC G06Q 40/08; H04L 9/32; G06F 16/27

(57) ABSTRACT

A computer system for conducting proof of insurance using a blockchain configured to (i) receive a request for proof of insurance for a driver of a vehicle; (ii) search a blockchain for a most recent new policy entry associated with one or more of the driver and the vehicle, the blockchain includes a plurality of policy entries associated with vehicle insurance policies and a plurality of title entries associated with state property titles; (iii) determine that an active policy for the driver exists within the blockchain; and (iv) transmit an alert message indicating that the proof of insurance has been verified for the driver.

### CROSS-REFERENCE TO RELATED APPLICATIONS

This application claims priority to and the benefit of the filing date of U.S. Provisional Application No. 62/866,995 filed on Jun. 26, 2019, entitled “SYSTEMS AND METHODS FOR DECENTRALIZING VEHICLE REGISTRATION USING BLOCKCHAIN,” and U.S. Provisional Application No. 62/827,507 filed on Apr. 1, 2019, entitled “SYSTEMS AND METHODS FOR DECENTRALIZING VEHICLE REGISTRATION USING BLOCKCHAIN,” the entire contents and disclosures of which are hereby incorporated by reference in their entirety.

### FIELD OF THE DISCLOSURE

The present disclosure relates to blockchain technology and, more particularly, to a network-based system and method for leveraging blockchain technologies between government agencies and insurance providers to decentralize aspects of vehicle registration.

### BACKGROUND

When registering a motor vehicle with a state agency, such as a state's department of transportation (DOT) or department of motor vehicles (DMV), drivers typically need to provide proof of insurance (POI) (e.g., when registering or titling a vehicle, when renewing license plates). Further, police officers typically ask for proof of insurance along with driver's license during traffic stops. Conventional means for proving insurance typically includes showing an insurance card to the state agency or to the police officer. However, there are numerous problems with such conventional means, such as the driver not having a current proof of insurance card, or a vehicle identification number (VIN) mismatch between the actual vehicle, the VIN appearing on a title for the vehicle, and the VIN associated with the insurance policy. What is needed is a system for reconciling data between insurance providers and state agencies that reduces errors during proof of insurance.

### BRIEF SUMMARY

The present embodiments relate to blockchain based systems and methods for decentralizing aspects of vehicle registration and proof of insurance between state agencies and insurance providers. The platform may include one or more insurance provider servers, one or more state agency servers, a reconciliation service server, one or more personal computing devices (e.g., of drivers), and one or more smart vehicles.

The present disclosure relates to systems and methods for conducting proof of insurance using a blockchain. A computer system may be configured to: (i) receive a request for proof of insurance for a driver of a vehicle; (ii) search a blockchain for a most recent new policy entry associated with one or more of the driver and the vehicle, the blockchain includes a plurality of policy entries associated with vehicle insurance policies and a plurality of title entries associated with state property titles; (iii) determine that an active policy for the driver exists within the blockchain; and/or (iv) transmit an alert message indicating that the proof of insurance has been verified for the driver. The computer system may include additional, less, or alternate functionality, including that discussed elsewhere herein.

For instance, the computer system may also be configured to (v) update policy information from the new policy entry based upon one or more policy update entries in the blockchain associated with the new policy entry. The computer system may further be configured to (vi) update policy information from the new policy entry by overwriting one or more data elements of the policy information with one or more corresponding data elements included in a policy update entry having a more recent timestamp than the one or more data elements. The computer system may also be configured to (vii) search the blockchain for the one or more policy update entries subsequent to the new policy entry, including comparing timestamp information of the new policy entry to timestamp information contained within the one or more policy update entries. The computer system may further be configured to (viii) determine whether the vehicle has a valid title by searching the blockchain for a new title entry for the vehicle. The computer system may also be configured to (ix) search the blockchain for a new title entry for the vehicle by searching the blockchain for a new title entry that includes a vehicle identification number (VIN) matching a VIN associated with the new policy entry. The computer system may also be configured to (x) compare one or more policy data elements to one or more state requirements for vehicle insurance to determine that all of the one or more state requirements for vehicle insurance are met by the active policy. The computer system may also be configured to (xi) search the blockchain for the most recent new policy entry associated with one or more of the driver and the vehicle by searching the blockchain for the most recent new policy entry having a vehicle identification number (VIN) matching the vehicle.

The computer system may further be configured to (xii) receive a request to add a new policy to the blockchain; (xiii) create a new policy data record including a plurality of data elements representing aspects of the new policy; and (xiv) broadcast, to a peer-to-peer (P2P) network associated with the blockchain, the new policy data record as a new transaction to be added to the blockchain, the new transaction becomes the most recent new policy entry once added to the blockchain.

At least one advantage of this system is that the use of blockchain for tracking policy and title data allows for such data to be protected from tampering (e.g., due to the many distributed copies and the need for quorum amongst nodes). The addition of Update type entries into the blockchain in conjunction with ordered processing of update records over an initial new entry provides a mechanism for changing data previously memorialized into the blockchain without having to change the original record itself (an operation naturally restricted by blockchain). These advantages improve data integrity and protection.

In one aspect, a computer system for conducting proof of insurance using a blockchain is provided. The computer system may include at least one processor in communication with at least one memory device. The at least one processor is programmed to: (i) receive a request for proof of insurance for a driver of a vehicle; (ii) search a blockchain for a most recent new policy entry associated with one or more of the driver and the vehicle, the blockchain including a plurality of policy entries associated with vehicle insurance policies and a plurality of title entries associated with state property titles; (iii) determine that an active policy for the driver exists within the blockchain; and/or (iv) transmit an alert message indicating that the proof of insurance has been verified for the driver. The computer system may include additional, less, or alternate functionality, including that discussed elsewhere herein.

In another aspect, a computer-implemented method for conducting proof of insurance using a blockchain is provided. The method may be implemented on a computer system including at least one processor in communication with at least one memory device. The method includes: (i) receiving a request for proof of insurance for a driver of a vehicle; (ii) searching a blockchain for a most recent new policy entry associated with one or more of the driver and the vehicle, the blockchain including a plurality of policy entries associated with vehicle insurance policies and a plurality of title entries associated with state property titles; (iii) determining that an active policy for the driver exists within the blockchain; and/or (iv) transmitting an alert message indicating that the proof of insurance has been verified for the driver. The method may include additional, less, or alternate functionality, including that discussed elsewhere herein.

In yet another aspect, at least one non-transitory computer-readable storage media having computer-executable instructions embodied thereon is provided. When executed by at least one processor, the computer-executable instructions cause the processor to: (i) receive a request for proof of insurance for a driver of a vehicle; (ii) search a blockchain for a most recent new policy entry associated with one or more of the driver and the vehicle, the blockchain including a plurality of policy entries associated with vehicle insurance policies and a plurality of title entries associated with state property titles; (iii) determine that an active policy for the driver exists within the blockchain; and/or (iv) transmit an alert message indicating that the proof of insurance has been verified for the driver. The computer-executable instructions may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary reconciliation blockchain system.

FIG. 2 depicts a view of an exemplary vehicle that may participate in the blockchain system shown in FIG. 1.

FIG. 3 illustrates a flow chart of an exemplary computer-implemented process for adding and updating a policy in the blockchain shown in FIG. 1.

FIG. 4 illustrates a flow chart of an exemplary computer-implemented process for adding and updating a title in the blockchain shown in FIG. 1.

FIG. 5 illustrates a flow chart of an exemplary computer-implemented method (“POI process”) for performing proof of insurance of a driver and associated vehicle in the blockchain shown in FIG. 1.

FIG. 6 depicts an exemplary configuration of server computing device.

FIG. 7 depicts an exemplary configuration of user computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for decentralizing aspects of vehicle registration and proof of insurance using blockchain technologies. Proof of insurance may be required for certain government registrations such as, for example, proof of auto insurance to acquire or renew a driver's license or proof of home insurance to close on a mortgage loan. Various problems can occur during proof of insurance. For example, an insurance company may incorrectly list a VIN for a vehicle on an insurance policy, the policy may be below a minimum threshold of liability coverage for a particular state, or the vehicle may not be titled in the state listed in the policy. Such inconsistencies may lead to an inability of a driver of the vehicle to prove insurance, which may lead to negative consequences such as a state's refusal to renew a vehicle's license plate, fines from traffic tickets for not having provable insurance, and possibly increased insurance rates as a fallout of the traffic tickets. Further, such inconsistencies lead to an excessive amount of computer processing in attempts to reconcile inconsistencies between insurers and state agencies. Numerous file transfers and reconciliation attempts may be made over weeks or months, between and by insurers and state agencies, in an effort to remediate such inconsistencies.

These and other technical problems with vehicle registration and proof of insurance are addressed by a Reconciliation Blockchain System (“RBS”) described herein. The RBS uses a blockchain as a distributed database, or journal, that uses cryptography to maintain a continuously-growing list of ordered records, known as blocks. Each block may contain at least a timestamp and a link to the previous block in the chain, as well as one or more transactions (e.g., journal entries). The link to the previous block may be a hash of the previous block. For an insurance contract, for example, one block may contain an initial contract between a driver and an insurer. A next block may contain a modification to the contract that was requested by the driver and approved by the insurer, and may also contain a hashed copy of the previous block as well. Another block may contain one or more additional terms for the insurance contract and a hashed copy of the previous block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

In an exemplary embodiment, insurance providers and state agencies (e.g., state DMVs) participate in a reconciliation blockchain network, where each participating server may act as a node in the blockchain network. A blockchain of the network acts as a distributed journal that is used to facilitate proof of insurance and other related tasks between the insurance providers, the state agencies, and drivers (e.g., in an automobile context). In some embodiments, the blockchain network may include personal computing devices of drivers or vehicle computing devices of the vehicles owned by the drivers (e.g., smart cars) or state agency vehicles (e.g., smart police cars).

In some embodiments, the blockchain network may also include a reconciliation service server (e.g., another node) that provides certain processing services within the blockchain network. In alternate embodiments, the blockchain may be used to facilitate other insurer/state agency functionality, such as proof of home owner insurance for mortgage closings, life insurance situations, and/or medical insurance situations, proof of state specific coverages, proof of insurance with a specific insurance company, and proof of medical insurance.

In the exemplary embodiment, the blockchain is built with journal entries (e.g., transactions) that provide data about insurance policies of drivers. Insurance policy information may be added, changed over time, and may eventually expire (e.g., at the end of the active date range) and be renewed. The insurance company provides journal entries into the blockchain for any new policy or change in an existing policy. As such, the blockchain serves, at least in part, as a historical record of insurance coverage for a particular vehicle.

For example, an insurance provider may broadcast a “new insurance policy” entry indicating that a particular driver has an insurance policy. The entry may include policy information such as, for example, driver identification information (e.g., name, address, state-issued driver identifier (ID)) for the policy holder, an amount of liability coverage, an effective date range of the policy (e.g., start date, end date), a VIN number of one or more vehicles covered by the policy, insurance provider identification information (e.g., name or ID of the insurance company), a state of coverage of the policy, and so forth. The blockchain network (e.g., the nodes of the network) validates the transaction and add the transaction to a block in the blockchain.

In the exemplary embodiment, state agencies and drivers may use the blockchain to determine POI for the driver (e.g., when the driver renews their license plates, during a traffic stop by a police officer, purchasing a vehicle, renting a vehicle, ride-sharing instances, transportation company instances, when applying for an auto loan, when submitting a reservation for lodging, etc.). For example, a state agency representative may cause the state agency server to query the blockchain to determine if there is an active insurance policy for the driver and the VIN of the vehicle. Searching the blockchain may include, for example, identifying a “new insurance policy” entry having the VIN within the entries in the blockchain, identifying a “policy update” entry for a policy having that VIN, identifying the most recent entry for that VIN, or identifying any entry for the VIN and tracing through a linked network of entries for that VIN to find the most recent status of insurance for that vehicle.

If an entry is found, and if the policy is still active (e.g., within the coverage date range, not otherwise updated as expired, or such), then the POI has been successfully established for the driver. In this manner, the blockchain provides information from which the investigating device can establish current information (e.g., status of the policy, coverage of the policy, and so forth). In another example, a police officer may use their smart police car or remotely prompt the state agency server to similarly conduct POI of the driver or vehicle during a traffic stop. Such a search may be performed using the VIN of the vehicle, driver identification information, or license plate information of the subject vehicle. If a valid entry is found for the driver, then POI has been successfully established for the driver.

In the exemplary embodiment, the blockchain may also be built with journal entries that provide data about property titles (e.g., vehicle titles). State title information about properties such as vehicles may be added or changed over time. A state agency may provide journal entries into the blockchain for new titles or changes to existing titles. As such, the blockchain serves, at least in part, as a historical record of property titles for a particular property (e.g., vehicle). In some embodiments, the blockchain may be used for proof of ownership, proof of assets, or proof of agreement. For example, the blockchain may be configured for asset tracking for collectables (e.g., vintage guitars, sports memorabilia), jewelry, art, cameras, digital assets, and such. In some embodiments, the blockchain may be configured to track liens, loans, tax payments, or other types of debts or other owed amounts on various assets (e.g., market value fo the asset, loans associated with the asset, payoff amount, vehicle condition, to facilitate purchase, titling, and sale of assets). In some embodiments, the blockchain may be configured to track emissions testing information and service records for vehicles, vehicle recall notices, and other vehicle life cycle information affecting current value and condition.

For example, a state agency may broadcast a “new title” entry indicating that a new title has been issued for a particular vehicle (e.g., identified by VIN) or an “update title” entry indicating a change in status of an existing title (e.g., active, total loss, salvage, flood, theft, sale). The entry may include title information such as, for example, a VIN of the vehicle, a make and model of the vehicle, a state identifier of the issuing state, a title identifier, property owner information (e.g., driver name, home address, state driver ID, and so forth), an odometer reading of the vehicle at the time of titling, and so forth. When the state agency submits the title entry, the blockchain network (e.g., the nodes of the network) validates the transaction and add the transaction to a block in the blockchain.

In the exemplary embodiment, before creating a new title for a vehicle, the state agency may conduct a POI examination of the requesting owner (e.g., the driver). Like the POI examination described above, the state agency server may examine the blockchain to determine whether the driver has active insurance at or above any state-mandated minimum coverage threshold. The vehicle may be identified within the blockchain (e.g., within particular insurance policy transactions within the blocks) by, for example, the VIN for the vehicle, the identity of the driver, or title information for a previous title (e.g., a title identifier and state from another state's title). Once POI for the driver has been established, the POI requirement for new title may be satisfied and, barring other requirements, the state may continue issuing a new title for the vehicle under their particular state (e.g., by broadcasting a “new title” transaction into the blockchain). In same-state sales (e.g., buyer and seller both residing in the same state), the title may be updated with seller information after a sale, or a new title may be created after the sale.

In some situations, there may be discrepancies within the blockchain that cause a POI examination to improperly fail (e.g., determine that the driver or vehicle is not insured when, in fact, the driver or vehicle is insured). For example, if there is a mismatch between the VIN provided by the insurance provider (e.g., within the insurance policy entries of the blockchain) and the VIN provided for titling (e.g., on an existing title of the state or otherwise provided at time of a request for titling), then the POI examination may fail to connect the title with the insurance policy.

In the exemplary embodiment, a reconciliation service agent is provided within the blockchain system. The reconciliation service agent is configured to, inter alia, detect inconsistencies within the blockchain and trigger remediation actions or other automatic actions to address the inconsistencies. The reconciliation service agent may be configured to inspect new transactions added to the blockchain and trigger actions based upon certain new transactions. For example, if a “new insurance policy” entry is added to the blockchain (e.g., when a driver acquires a new insurance policy with an insurance provider), the reconciliation service agent may be configured to determine whether or not a vehicle associated with that new policy is titled in the state for which the insurance policy covers.

If there is no title in the state of coverage of the policy, or within the state of residence of the driver, this indicates a potential discrepancy between the insurance policy and titling of the vehicle (e.g., because the driver has recently moved to the state and has not yet titled the vehicle, because there is a data discrepancy between the insurance policy and any existing title, or such). In this situation, the reconciliation service agent may, for example, trigger an alert action to notify the insurance provider or the driver of a missing or unidentified title. For another example, if an “update insurance policy” entry is added to the blockchain, the reconciliation service agent may examine aspects of the insurance policy and the title for inconsistencies or other violations (e.g., lowering the coverage threshold below a state minimum, mismatch between VINs or other overlapping data). In some embodiments, the blockchain may be configured to automatically generate the title (e.g., via stored procedure, if the blockchain includes enough data to validate). In some embodiments, a missing title may trigger a match for a loan, a search for a rebranded title in other states, or a search of internet sales data.

In some embodiments, the blockchain includes stored procedures (e.g., smart contracts, chaincode) that are configured to automatically perform certain functionality within the blockchain. For example, the blockchain may include stored procedures for matching, updating, and outputting a title statement of record (SOR) with an insurance SOR, validating, updating, and outputting insurance dates and state minimum coverages, pend matches into queue to wait for trigger (e.g., brand new vehicles in queue pended to wait for DMV title), manage error queue to pend, resend, and resolve mismatches through intelligent processing, send notifications (e.g., when insurance status changes), or provide historical data stream to troubleshoot and predict deviation and potential fraud.

At least one of the technical problems addressed by this system may include: (i) improving sharing of policy and title data amongst multiple interested parties; (ii) allowing blockchain to protect data integrity to entries added into the blockchain, making hacking of the blockchain economically inefficient and extremely difficult; (iii) providing smart contracts within the blockchain that can automatically execute stored procedures affecting policies and titles; and/or (iv) adding update entries that can override earlier policy or title data in the blockchain, allowing data within the blockchain to be effectively overwritten without having to edit original entries.

The methods and systems described herein may be implemented using computer programming or engineering techniques including computer software, firmware, hardware, or any combination or subset thereof, wherein the technical effects may be achieved by performing at least one of the following steps: (a) receiving a request for proof of insurance for a driver of a vehicle; (b) searching a blockchain for a most recent new policy entry associated with one or more of the driver and the vehicle, the blockchain includes a plurality of policy entries associated with vehicle insurance policies and a plurality of title entries associated with state property titles; (c) determining that an active policy for the driver exists within the blockchain; and (d) transmitting an alert message indicating that the proof of insurance has been verified for the driver.

Additional technical effects may be achieved by performing at least one of the following steps: (e) update policy information from the new policy entry based upon one or more policy update entries in the blockchain associated with the new policy entry; (f) overwriting one or more data elements of the policy information with one or more corresponding data elements included in a policy update entry having a more recent timestamp than the one or more data elements; (g) search the blockchain for the one or more policy update entries subsequent to the new policy entry, including comparing timestamp information of the new policy entry to timestamp information contained within the one or more policy update entries; (h) determine whether the vehicle has a valid title by searching the blockchain for a new title entry for the vehicle; (i) searching the blockchain for a new title entry that includes a vehicle identification number (VIN) matching a VIN associated with the new policy entry; (j) compare one or more policy data elements to one or more state requirements for vehicle insurance to determine that all of the one or more state requirements for vehicle insurance are met by the active policy; (k) searching the blockchain for the most recent new policy entry having a vehicle identification number (VIN) matching the vehicle; (l) receive a request to add a new policy to the blockchain; (m) create a new policy data record including a plurality of data elements representing aspects of the new policy; and (n) broadcast, to a peer-to-peer (P2P) network associated with the blockchain, the new policy data record as a new transaction to be added to the blockchain, the new transaction becomes the most recent new policy entry once added to the blockchain.

Additionally, the present embodiments may provide a process to decentralize vehicle registration and insuring vehicles by reconciling vehicle title data with vehicle insurance data in real-time to assess proof of insurance for a particular vehicle in an electronic format. The present embodiments may: (a) provide a real-time process to electronically validate data from various locations; (b) infer, predict an/or validate proof of insurance, and determine level of certainty and potential missing, mismatched or incorrect information; (c) provide the ability to adjust insurance rates based upon title status and changes; (d) provide the ability to change rates, named insured, and/or coverages based upon title updates; and/or (e) provide the ability to offer new products and services.

Furthermore, the present embodiments may provide a process to create a historical transaction chain of significant transactions while dropping off insignificant transactions. The present embodiments may (1) create a consumer grade, virtual, electronic and portable proof of insurance where a driver can select what level of detail of proof of insurance and in what format and to which external parties to share. This data could be used like a credit score to secure products such as car loans, car sharing and ride sharing. The present embodiments may (2) track vehicles registrations and insurance across state lines and countries for use in detecting fraud from title laundering, total loss flood vehicles, etc. The present embodiments may (3) combine insurance, title data, VIN and usage-based insurance data (telematics) to predict loss, usage, useful life, crash risk, market value, upside down on auto loan, payoff amounts on total losses, and/or projected life of vehicle.

The present embodiments may also (4) create virtual graphics of life history of vehicle to determine: (i) principal driver and secondary drivers; (ii) loan amount; (iii) loan company; (iv) type of title; (v) mileage; (vi) estimated value of vehicle; (vii) loan to value ratio; (viii) depreciation schedule; (ix) projected life of vehicle; (x) automated depreciation schedule for insurance; (xi) telematics data (cornering, braking, speed, location, route, heading, time-of-day information, etc.) associated with the vehicle; and/or (xii) telematics data associated with a primary or secondary driver.

### Exemplary Reconciliation Blockchain System and Network

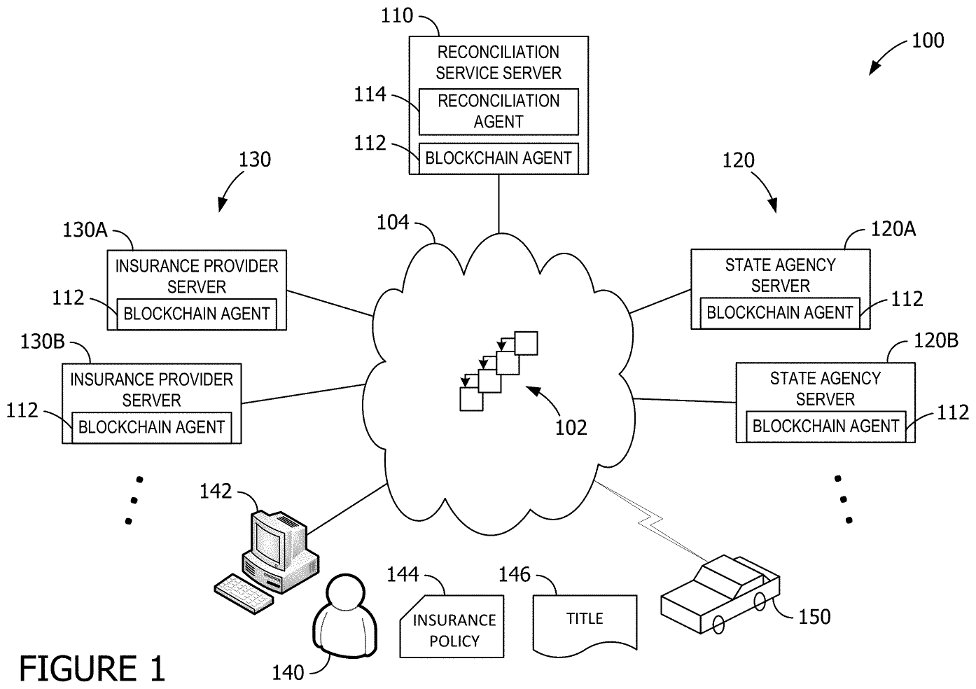

FIG. 1 depicts an exemplary reconciliation blockchain system (or just “RBS” or “blockchain system”) 100. In the exemplary embodiment, the RBS 100 includes a peer-to-peer (“P2P”) network 104 of computing devices (e.g., nodes) that participate in a blockchain 102 that is distributed amongst the participants and that is used for managing aspects of property insurance and titling (e.g., automobile insurance and automobile property titles). The peer-to-peer network 104 includes state agency servers 120 (representing, e.g., state DMVs, state DOTs) and insurance provider servers 130 (representing, e.g., insurance providers or third parties). In some embodiments, the peer-to-peer network 104 also includes a reconciliation service server 110 that may perform aspects of functionality within the RBS 100. In some embodiments, drivers 140 or law enforcement officers (not separately depicted) may participate in the peer-to-peer network 104 (e.g., via personal computing devices 142 or smart vehicles 150). The peer-to-peer network 104 may be implemented over a shared network such as the Internet or over a private or semi-private network.

While only two state agency servers 120A, 120B, two insurance provider servers 130A, 130B, one reconciliation service server 110, one personal computing device 142, and one smart vehicle 150 are depicted in FIG. 1, it should be understood that any number of such participants may participate in the RBS 100. For example, each participating state may have one or more state agency servers 120, each participating insurance provider has at least one insurance provider server 130, and there may be numerous smart vehicles 150 of drivers 140 and state and local law enforcement departments participating in the RBS 100. In some embodiments, state agencies 120 may include one or more state licensing offices, state tax offices, or other such state entities that may perform POI or other titling or insurance investigatory or management functionality.

The term “participant” is used herein to refer, collectively or singularly, to any or all of the computing devices, or their respective real-world parties, that participate in the P2P network 104 of the RBS 100 (e.g., devices or nodes that conduct transactions within the blockchain 102, analyze the blockchain 102, and such). Further, the real-world parties that participate in the P2P network 104 may be identified herein based upon their associated computing devices (e.g., insurance provider servers 130 or insurance providers 130, state agency servers 120 or state agencies 120, and so forth). While an insurance policy 144 and a title 146 are depicted in FIG. 1 for ease of explanation, as they are a subject of the blockchain 102, it should be understood that insurance policies 144 and titles 146 are not participants.

In the exemplary embodiment, the blockchain 102 is a distributed database, or journal, that uses cryptography to maintain a continuously-growing list of ordered records, grouped together in blocks (not separately depicted). Each block may contain a timestamp and a link to the previous block in the chain, as well as one or more transactions (e.g., journal entries), as is known in the art. The various participants in the RBS 100 may, for example, broadcast transactions related to insurance policies 144 or titles 146 that are added to the blockchain 102 as records or entries. The term “transaction,” as used herein, refers to a blockchain mechanic of adding a record to a block in the blockchain, and does not necessarily indicate a financial exchange of value. In other words, and unlike records in known cryptocurrency blockchain implementations (e.g., Bitcoin), the data within records in the blockchain 102 of the present disclosure do not necessarily represent financial transactions between parties.

In the exemplary embodiment, the blockchain 102 is used by the participants to record and track aspects of insurance policies 144 and state property titles 146. Journaling information related to insurance policies and property titles within the blockchain 102 allows state agencies 120 to use the blockchain 102 for proof of insurance (e.g., whether the driver 140 has an active insurance policy 140 covering a particular vehicle at a particular minimum coverage level). Each participant in the P2P network 104 includes a blockchain agent 112, which allows the associated computing device to participate in the P2P network 104 (e.g., making that computing device a node within the network 104).

In other words, the blockchain agent 112 represents the local executable programming that allows the hosting computing device to perform fundamental blockchain mechanics such as, for example, adding entries to the blockchain, reading data from the blockchain, or other blockchain “mining” or known blockchain functionality that enables the systems and methods described herein. In some embodiments, personal computing devices 142 or smart vehicles 150 may also contain blockchain agents 112, thereby allowing those computing devices to participate in the P2P network 104 and access the blockchain 102.

During operation, state agencies 120 and insurance providers 130 add various entries to the blockchain 102, making those entries a part of the permanent record of the blockchain 102. More specifically, in the exemplary embodiment, state agencies 120 add title type entries to the blockchain 102 (e.g., reflecting new or updated state property titles 146) and insurance providers 130 add insurance policy type entries to the blockchain 102 (e.g., reflecting new insurance policies or changes to such insurance policies 144). Such entries may be used, inter alia, to evaluate proof of insurance for drivers 140, as described in further detail below. The term “entry,” as used herein, refers to a data record (e.g., transaction) added to the blockchain 102.

In the exemplary embodiment, there are two title-type entries that can be added to the blockchain 102:
New Title; and
Title Update,
   and there are two policy-type entries that can be added to the blockchain 102:
New Policy; and
Policy Update.

Title type entries to the blockchain 102, in the exemplary embodiment, include a “New Title” type entry that is used, for example, when a state creates a new property title 146 (e.g., a vehicle title). In one example, a New Title-type entry for a vehicle includes vehicle information (e.g., VIN, year, make, model), owner information (e.g., name, address, state driver identification, contact number), and state title information (e.g., state identifier, title type, title number or other unique identifier, purchase date, mileage at time of transfer, buyer information, and may include or otherwise reference or link to lienholder information for liens on the underlying vehicle). A state agency server 120 of the titling state (or some third-party representative, such as the reconciliation service server 110, delegated to perform such duties on behalf of the state) creates the New Title-type entry for a new title 146 and broadcasts the New Title-type entry into the P2P network 104 for addition to the blockchain 102.

Based upon the mechanics of blockchain technology, once an entry is added to the blockchain 102 (e.g., broadcast to the nodes within the P2P network 104 of the blockchain system 100), it cannot practically be modified or deleted. To address this feature of blockchain technology with the potential for erroneous data or dynamic changes to data in property titles 146, in the exemplary embodiment, an existing title may be supplemented within the blockchain using a “Title Update” type entry. In some embodiments, a Title Update-type entry includes all of the same data fields of a New Title-type entry, but one or more of the data fields may include different data (e.g., updated data). A Title Update-type entry may identify, be linked to, or otherwise may be associated with an existing title within the blockchain 102 (e.g., a New Title-type entry for an existing title 146). For example, the Title Update-type entry may provide linking information such as a VIN associated with the title 146, a unique entry identifier for the New Title entry (e.g., a blockchain identifier or an identifier created for tracking transactions in the blockchain system 100), a title number, or a blockchain link to the blockchain transaction of the New Title entry.

Title Update-type entries may include some types of information that appear in New Title-type entries (e.g., as described above). In other words, most data elements that may appear in a New Title-type entry may appear in a Title Update-type entry, thereby providing a mechanism for updating, changing, or correcting information in the New Title-type entry without actually altering the New Title-type entry (e.g., because of the restrictions provided by blockchain). In some embodiments, any data elements that are configured to be provided in New Title-type entries may be updatable by a Title Update-type entry. In some embodiments, certain types of data elements that appear in New Title-type entries may not be updatable by a Title Update-type entry. For example, data that is relied upon to uniquely identify a transaction within the blockchain may not be “overridden” with a Title Update-type entry.

In some embodiments, Title Update-type entries may include additional data elements not previously included in the New Title-type entry (e.g., types of data elements that are valid for Title type entries). For example, a new title may have been added without an address for the owner 140, and a Title-Update entry may be used to add address information for the owner 140. In some embodiments, Title Update-type entries may include marriage information (e.g., adding spouse, dependents), adding dependent drivers, updated address information, change title type, color, VIN, or such. An insurance provider server 130 creates the Title Update-type entry for the existing title 146 and broadcasts the Policy Update-type entry into the P2P network 104 for addition to the blockchain 102.

Insurance policy type entries to the blockchain 102, in the exemplary embodiment, include a “New Policy” type entry that is used, for example, when an insurance provider creates a new insurance policy 144 (e.g., a vehicle insurance policy for a driver 140). In one example, a New Policy-type entry for a vehicle insurance policy includes vehicle information (e.g., VIN, year, make, model), driver information (e.g., name, address, state driver identification, contact number), and insurance information (e.g., a unique policy number assigned to the policy by the insurer, policy status, date range of coverage, coverage type, coverage amount(s)). For example, the New Policy-type entry may include an insurer-provided policy number for the policy 144, a VIN associated with a vehicle being covered by the policy 144, a date range of coverage for the policy 144 (e.g., start date and end date), state driver identification information for one or more drivers 140 covered by the policy 144 (e.g., name, address, state driver ID), and a liability coverage amount for the policy 144. An insurance provider server 130 creates the New Policy-type entry for a new insurance policy 144 and broadcasts the New Policy-type entry into the P2P network 104 for addition to the blockchain 102.

In some embodiments, a New Policy-type entry may include state title information of one or more vehicles covered by the policy 144 (e.g., state identifier, title type, title number or other unique identifier, purchase date, mileage at time of transfer, buyer information, and may include or otherwise reference or link to lienholder information for liens on the underlying vehicle). In some embodiments, a New Policy-type entry may include a link to a New Title-type entry for a title 146 to one or more vehicles covered by the policy 144.

To address the potential for erroneous data or dynamic changes to data in insurance policies 144, in the exemplary embodiment, an existing insurance policy may be supplemented within the blockchain using a “Policy Update” type entry. In some embodiments, a Policy Update-type entry includes all of the same data fields of a New Policy-type entry, but one or more of the data fields may include different data (e.g., updated data). A Policy Update-type entry may identify, be linked to, or otherwise may be associated with an existing policy within the blockchain 102 (e.g., a New Policy-type entry for an existing insurance policy 144). For example, the Policy Update-type entry may provide linking information such as a VIN associated with the policy 144, a unique entry identifier for the New Policy entry (e.g., a blockchain identifier or an identifier created for tracking transactions in the blockchain system 100), a policy number, or a blockchain link to the blockchain transaction of the New Policy entry.

Policy Update-type entries may include some types of information that appear in New Policy-type entries (e.g., as described above). In other words, most data elements that may appear in a New Policy-type entry may appear in a Policy Update-type entry, thereby providing a mechanism for updating, changing, or correcting information in the New Policy-type entry without actually altering the New Policy-type entry (e.g., because of the restrictions provided by blockchain). In some embodiments, any data elements that are configured to be provided in New Policy-type entries may be updatable by a Policy Update-type entry. In some embodiments, certain types of data elements that appear in New Policy-type entries may not be updatable by a Policy Update-type entry. For example, data that is relied upon to uniquely identify a transaction within the blockchain may not be “overridden” with a Policy Update-type entry.

In some embodiments, Policy Update-type entries may include additional data elements not previously included in the New Policy-type entry (e.g., types of data elements that are valid for Policy type entries). For example, a new policy may have been added without a VIN for one of the owner 140's vehicles, and a Policy-Update entry may be used to add vehicles or vehicle VINs to the insurance policy 144. In some embodiments, Policy Update-type entries may include a change in title type (e.g., “salvage”), new owner information, color change, address, or lien holder information. An insurance provider server 130 creates the Policy Update-type entry for the existing insurance policy 144 and broadcasts the Policy Update-type entry into the P2P network 104 for addition to the blockchain 102.

In some embodiments, the blockchain 102 may track lien information within the blockchain 102, and that lien information may be linked to other entries in the blockchain 102 (e.g., to VIN, title, or insurance-related entries). Banking institutions may participate in the blockchain 102 to facilitate lien entries in the blockchain 102. For example, the blockchain 102 may provide New Lien-type and Lien Update-type transactions in the blockchain 102, allowing a bank or other lien holder or lender to enter a lien or other record of a loan obligation, encumbrance, or security interest over an asset (e.g., mortgage, mechanics lien, tax lien, judgment lien, and such) as transactions in the blockchain 102. A New Lien-type transaction may, for example, identify a lien on a vehicle. Such New Lien-type transactions may be linked within the blockchain 102 to the applicable asset (e.g., a particular vehicle, by VIN; a title entry in the blockchain 102, an insurance policy, and such). Subsequent Lien Update-type transactions may be entered into the blockchain 102 to update the status of the lien or other lien information. For example, upon satisfaction of a lien, the lien holder may enter a Lien Update-type transaction that updates a lien status to “satisfied,” thereby memorializing removal of the lien from the underlying asset. As such, the blockchain 102 may be used as a statement of record for loan and lien information. In some embodiments, the blockchain 102 may log inquiries or police reports associated with assets.

The data for each particular entry is constructed (e.g., by a blockchain agent 112 of a state agency server 120) as a text-based data record to be added to the blockchain 102. For example, the record format may include:

<entry ID>, <entry type>, <property ID>, <entry-type specific data>

where <entry ID> is a unique ID that may be used to reference this particular entry (e.g., within the blockchain 102), <entry type> is a data field (e.g., integer, character string) indicating the type of entry (e.g., new title, title update, new policy, policy update), <property ID> is a data field (e.g., a fixed-length string) representing, for example, the VIN of the vehicle associated with this entry, and where <entry-type specific data> are one or more data elements (e.g., a fixed or variable length data sub-record) that includes additional data elements formatted or otherwise interpreted based upon the <entry type>. In some examples, <entry-type specific data> may include market value, owner information, insurance company information, lien holder information, motor vehicle record (MVR), other vehicles titled by owner, and such. Each entry type has a standardized set of data fields that are valid for entries of that type. In some embodiments, the <entry-type specific data> may be formatted as a record of fixed-length data fields of a prescribed format (e.g., one field for each possible type of data). In other embodiments, the <entry-type specific data> may be formatted as a JavaScript Object Notation (JSON) string of data elements. In other embodiments, the <entry-type specific data> may be formatted as a delimited set of field, value pairs. As such, each entry includes at least an entry type, a VIN, and the additional data supporting that type of entry.

Various parties to the blockchain system 100 use the blockchain 102, and the various entries to the blockchain 102 discussed above, for titling and proof of insurance. In the exemplary embodiment, state agencies 120 may use the blockchain 102 to title the vehicle and to establish POI for the driver 140 of a vehicle. For example, the driver 140 may be at a state DMV attempting to register a vehicle with the state (e.g., acquire a new license plate in that state) or to renew their state-issued license plate. At such time, states may require previous titling from another state, MVR, inspections such as emissions and safety, lien holder information, or proof of insurance. Proof of insurance typically requires a showing that a policy of the driver 140 is currently active for the vehicle and that the policy includes liability coverage above a minimum threshold amount (e.g., per accident).

To facilitate proof of insurance, in the exemplary embodiment, the state agency server 120 may inspect the blockchain 102 for insurance information of the driver 140 using search criteria. For example, when applying, the driver 140 may present a VIN of their vehicle, an insurance policy number for their policy 144 (e.g., from an insurance card), their state driver identification (e.g., from their drivers license), or other identifying information. The state agency server 120 uses the provided information to inspect the blockchain 102, looking for entries in the blockchain 102 (e.g., transactions) matching the search criteria. More specifically, in one embodiment, the state agency server 120 locates New Policy-type entries matching the search criteria and may automatically select the most recent matching New Policy-type entry (e.g., based upon timestamp information memorialized in the blockchain transaction for that entry). When two New Policy-type entries match but one is more recent than the other, the more recent of the two may be more likely to be the proper entry. In other embodiments, multiple matching entries may be displayed to a user of the state agency server 120 (e.g., a DMV employee or representative), along with associated information, and the user may inspect the entries or select a particular entry as applicable to the driver 140.

It is possible that the information of the identified New Policy entry has changed (e.g., with by one or more Policy Update-type entries). In the exemplary embodiment, the state agency server 120 updates the “base policy information” found in the New Policy entry with any subsequent updated information from any Policy Update entries for that policy entered after the New Policy entry (e.g., based upon timestamp information). As such, the state agency server 120 creates a “latest version” of the policy 144 in which each data element is at its most current value. More specifically, the state agency server 120 searches for Policy Update-type entries linked to or otherwise associated with the identified New Policy entry and with timestamps occurring later in time than the New Policy entry. In some embodiments, the state agency server 120 processes each identified Policy Update-type entry in order from oldest to newest, replacing any updated data elements with the more recent data, or adding any newly introduced data elements to the current version of the policy 144. For example, if the policy 144 originally contains a data element “address=1234 Park Place” as recorded in the New Policy entry and a later-in-time Policy Update entry for this policy 144 includes a data element “address=5678 Boardwalk Avenue” (e.g., after the driver 140 moves to a different residential address), the original address from the New Policy entry will be overridden and replaced with the “5678 Boardwalk Avenue” address.

Similarly, in the exemplary embodiment, current title information may be determined from the blockchain 102 based upon the most recent New Title-type entry for a property and subsequent Title Update-type entries for that property. States typically require that the vehicle of the driver 140 has a valid title 146 in that state, and that the insurance policy 144 covers that vehicle. However, there can sometimes be discrepancies between the policy 144 and the title 146 (e.g., mismatches in VIN number or other key data). As a part of the titling and registration process and the POI process described herein, the state agency server 120 may compare aspects of the title to aspects of the policy 144 (e.g., to ensure that the policy and the title are associated with the same vehicle).

As such, the state agency server 120 determines the latest version of the policy 144 for the driver 140, as well as the title 146 of the vehicle, from the blockchain 102. Once determined, in the exemplary embodiment, the state agency server 120 compares the insurance policy 144 to one or more state-mandated criteria necessary for POI. In one example embodiment, the state requires a valid, currently active policy for the subject vehicle, having a liability coverage maximum at or above a minimum level (“state minimum coverage threshold”), and that the subject vehicle be titled in the state. Accordingly, the state agency server 120 compares each requirement to an associated data element of the policy 144 to determine whether all of the state requirements are met for POI. Further, the state agency server 120 compares data elements of the policy 144 to data elements of the title 146 (e.g., comparing the VIN appearing in the policy 144 to the VIN appearing in the title 146). If a valid and matching title exits for the vehicle, and if all of the requirements for POI are satisfied based upon the latest version of the policy 144 for the driver 140, then the state agency issues or renews the registration for the vehicle.

In some situations, there may be a discrepancy between the insurance policy 144 of a driver 140 and the title 146 to their vehicle. For example, one frequent discrepancy that can occur between policy 144 and title 146 is non-matching VIN. An incorrect VIN may have been improperly entered on either the policy 144 (e.g., the real-world policy documentation), the title 146 (e.g., the real-world title documentation), both the policy 144 and the title 146, or within the corresponding entries in the blockchain 102 (e.g., in the New Policy entry or the New Title entry). In some embodiments, other discrepancies may be addressed in the blockchain 102. For example, discrepancies in name, address, lien holder, policy number, titles between other states, year, make, model, effective date, coverages, agent, or insurance company may be addressed in the blockchain 102.

In the exemplary embodiment, the blockchain system 100 includes a reconciliation agent 114 that is configured to discover and address such discrepancies. The reconciliation agent 114 executes on a reconciliation service server 110 that participates in the P2P network 104 and the blockchain 102. The reconciliation agent 114, through use of the local blockchain agent 112, examines entries in the blockchain 102 and may automatically execute one or more of the triggered processes described herein (e.g., based upon entries found within the blockchain 102 or some other triggering condition).

In one example embodiment, the reconciliation agent 114 identifies discrepancies within the blockchain 102 between the policy 144 and an associated title 146 in a policy/title reconciliation process. The reconciliation agent 114 may, for example, compare data elements of the New Policy entry for the policy 144 (e.g., and as updated with any subsequent Policy Update entries as described above) to data elements of the New Title entries for any associated vehicles (e.g., and as updated with any subsequent Title Update entries as described above). For example, the policy/title reconciliation process may include comparing a VIN of the policy 144 with a VIN of the associated title 146. If there is a mismatch between the VINs, this data discrepancy is identified for rectification. In some embodiments, the reconciliation agent 114 may transmit an alert to the policy holder (e.g., the driver), the insurance provider 130, or the state agency 120.

In some embodiments, the reconciliation agent 114 may enter a status update into the blockchain 102 for the policy 144 (e.g., with a Policy Update-type entry), the title 146 (e.g., with a Title Update-type entry), or both. For example, a status data element of the policy 144 or the title 146 may be updated in the blockchain 102 with a status code of “mismatched VIN”. The reconciliation agent 114 creates a new Update-type entry (e.g., Policy Update or Title Update), including the associated policy or title identification data elements along with a status data element set to the status code. Once created, the reconciliation agent 114 broadcasts the transaction into the P2P network 104 for addition to the blockchain 102.

In the exemplary embodiment, the data discrepancy between the policy 144 and the title 146 may be addressed and resolved in the blockchain 102. In some embodiments, the insurance provider 130 (or a third-party participant acting on behalf of the insurance provider 130) may enter a correction into the blockchain 102 to address the discrepancy with the policy 144, or the state agency 120 (or third-party participant) may enter a correction into the blockchain 102 to address the discrepancy with the title 146. This corrective action may, for example, be initiated in response to an alert sent from the reconciliation agent 114, or may be uncovered and corrected in response to a failed POI of the driver 140 (e.g., when trying to acquire or renew their license plates). Accordingly, the state agency 120 (e.g., in the case of an update to the title 146) or the insurance provider 130 (e.g., in the case of an update to the policy 144) composes an Update-type entry that includes the updated (e.g., corrected) data and broadcasts that transaction to the P2P network 104 for addition into the blockchain 102. In some embodiments, such data discrepancies may be automatically detected and remedied using smart contracts (e.g., stored procedures within the blockchain 102).

In some embodiments, the reconciliation agent 114 automatically examines new entries added into the blockchain 102 and automatically executes various triggered processes based upon new entries as they are added into the blockchain 102. For example, the reconciliation agent 114 may track which blocks in the blockchain 102 the reconciliation agent 114 has already examined. When a new (e.g., unexamined) block is added to the blockchain 102, the reconciliation agent 114 examines all of the new transactions in that new block. Each new transaction may potentially trigger a triggered process.

In some embodiments, the reconciliation agent 114 may be configured to automatically detect a dissociation between the policy 144 and the title 146 within the blockchain 102. Such dissociation broadly represents a policy within the blockchain 102 not having an association with a title within the blockchain 102. For example, the driver 140 may have recently moved to a new state, and the driver 140 may have updated their policy 144 with their new address in the state while not yet having titled their vehicle in that state. As such, the blockchain 102 may include a New Policy-type entry or a Policy Update-type entry identifying the new state for the policy 144, but there is no New Title-type entry in the blockchain 102 for the vehicle of the driver 140 in that state. In another example, the driver 140 may have applied for a new policy 144 for their recently purchased vehicle, but they have not yet titled the vehicle in the name of the driver 140. In another example, the insurance provider 130 may have incorrectly entered information into the policy 144 within the blockchain 102 (e.g., a VIN on the policy 144 that does not match any titles 146 of the driver 140 within the blockchain 102).

To automatically detect such dissociations, in the exemplary embodiment, the reconciliation agent 114 examines new New Policy-type entries or Policy Update-type entries added into the blockchain 102. When a Policy-type entry is found, the reconciliation agent 114 may be configured to automatically retrieve policy information from the Policy entry, such as name(s) and address of the policy holder(s) and one or more vehicle VINs. With this extracted information, the reconciliation agent 114 then searches through the blockchain 102 looking for the most recent title entries (e.g., New Title-type entries and any subsequent Title Update-type entries) matching the state and the VIN(s) from the New Policy. If no entry in the blockchain 102 is found for a particular VIN, then a dissociation is flagged for this New Policy accordingly. Such a dissociation may represent, for example, an error in the VIN of the New Policy, or that the vehicle associated with that VIN is not titled in the state.

If one or more titles are found in the blockchain 102 for a particular VIN, then title data from the most recent New Title entry is extracted from the blockchain 102 (e.g., from the New Title entry and as updated with any subsequent matching Title Update entries, as described above). The reconciliation agent 114 may then compare data components of the title data to data components of the New Policy. For example, the reconciliation agent 114 may compare policy holder data from the New Policy to owner information from the title data (e.g., to determine whether the policy holder is named on the title). If the policy holder is not named on the title, then a dissociation is flagged for this New Policy accordingly. The reconciliation agent 114 may also investigate a status of the title. If the title is listed, for example, as expired, cancelled, terminated, stolen, or otherwise invalid or inactive, then a dissociation is flagged for this New Policy accordingly. In some embodiments, the reconciliation agent 114 may query online vehicle sales sites, state DMVs, original equipment manufacturer (OEM) records, prior insurance carrier policies, or other such sources to determine if the vehicle has a prior history or validation.

In some embodiments, the dissociation determination process described above may be performed by a state agency server 120 or an insurance provider server 130 (e.g., during an application for license registration or for a new insurance policy, during POI at a traffic stop). As such, the driver 140 identifies the New Policy (e.g., via a policy number provided by their insurance provider), and the investigating server 120, 130 performs the examination of the blockchain 102 for dissociation, as described above.

In the exemplary embodiment, when a dissociation is flagged for a New Policy, the reconciliation agent 114 may automatically transmit an alert to the policy holder (e.g., the driver), the insurance provider 130, or the state agency 120. The alert may indicate that no title was active title was found for the associated VIN and driver. In some embodiments, these dissociations may be queued at the insurance provider server 130 or the state agency server 120 in a processing error queue to be addressed by that party, or may be transmitted to a personal computing device 142 (e.g., home personal computer or mobile device) of the driver 140. In some embodiments, the policy may be in a pending state (e.g., awaiting confirmation data form a driver, such as a photo of their VIN, or pending confirmation from another state title validation).

In some embodiments, entries in the blockchain 102 may include links from one transaction to another transaction. These links may be used to identify, for example a thread of related entries (“thread links”), such as a New Policy entry linked to a first Policy Update entry for that policy, and the first Policy Update entry linked to a second Policy Update entry for that policy (or similarly for New Title and Title Update entries). Such links may be provided as data elements in the entry, storing a unique transaction identifier of the entry in the blockchain 102. Each entry may include one or more directional links (e.g., one entry forward in a thread that starts with a New Policy-type or New Title-type entry, one entry backward toward the New-type entry, and so forth). Entries may be doubly linked, including both a forward link to the next entry in a thread and a backward link to the previous entry in a thread. Accordingly, any participant investigating the blockchain 102 may use the links to identify other associated transactions in a thread (e.g., using the transaction identifier provided in the link to find the identified transaction within the blockchain 102).

In some embodiments, links may be used to create associations between policies 144 and titles 146 within the blockchain 102 (“cross-links”). For example, a policy 144 may include one or more cross-links from the New Policy entry in the blockchain 102 to one or more New Title entries in the blockchain 102. As such, cross-links allow a known association between a policy 144 and one or more titles 146 to be memorialized within the blockchain 102, allowing for easier determination of associations between policies 144 and titles 146.

Accordingly, in some embodiments, when a Policy entry is examined and no dissociation is flagged (e.g., when title is confirmed), the reconciliation agent 114 may examine linkages between the Policy entries and the identified Title entries. If no cross-links exist in either the Policy entries any of the identified Title entries, the reconciliation agent 114 may be configured to automatically add cross-links to one or more of the Policy and the Title(s) within the blockchain 102 (e.g., via a Policy Update-type entry adding a reference to the identified New Title entries, via a Title Update-type entry adding a reference to the New Policy entry).

In some embodiments, some data within the blockchain 102 may be encrypted to hide information depending on various parties' permissioned access to particular data within the blockchain 102. In some embodiments, the blockchain 102 may include stored procedures that allow parties to submit a query and receive a response from the blockchain 102 without directly accessing underlying data associated with the query. For example, the blockchain 102 may be configured to search the blockchain 102 and answer a query to determine “Is <X> a valid VIN?” or “Is <X> insured with at least state minimum insurance requirements?” As such, the blockchain 102 may protect access to underlying data while also providing certain types of checks using that data.

In some embodiments, the blockchain system 100 is configured with one or more smart contracts built into the blockchain 102. Smart contracts include stored procedures built into the blockchain 102 that may be triggered based upon transactions occurring within the blockchain 102 (e.g., by any of the participating nodes).

For example, in one embodiment, the reconciliation agent 114 configures the blockchain 102 with a smart contract that sends notifications when an insurance policy 114 is changed within the blockchain 102 (“update notification procedure”). For example, the update notification procedure of this smart contract may be configured, upon submission of a Policy Update-type entry into the blockchain 102, to identify contact information for the policy holder (e.g., the driver 140) from the Policy thread in the blockchain 102, such as an email address or a mobile phone number. The update notification procedure may be configured to automatically transmit an update notification alert to the policy holder (e.g., via email, SMS text) alerting the policy holder of the change to their policy 144 within the blockchain 102.

In another embodiment, the reconciliation agent 114 configured the blockchain 102 with a smart contract that validates insurance dates and state minimum coverages of policies in the blockchain 102 (“policy validation procedure”). For example, the policy validation procedure of this smart contract may be configured, upon submission of a New Policy-type entry or a Policy Update-type entry, to examine the Policy thread of the associated policy 144 within the blockchain 102 for the most recent coverage amount of the policy 144, or for the coverage date range for the policy 144. Regarding coverage amount, the policy validation procedure may compare the coverage amount of the policy 144 to the minimum threshold coverage amount as defined by the state. Regarding coverage date range, the policy validation procedure may compare the current date to the coverage date range of the policy 144. If the coverage amount of the policy 144 does not satisfy the state minimum, or if the policy is not currently active (e.g., not now within the coverage date range), then the policy validation procedure may generate an alert to the policy holder (e.g., using the notification alert methodology described above) or to the insurance provider 130 (e.g., via alert notification message).

In some embodiments, the blockchain 102 may provide smart contracts (e.g., stored procedures) that are configured to provide various functionality for the blockchain 102 and various participants. In one embodiment, the blockchain 102 includes a smart contract that is configured to match, update, and output a title statement of record (SOR) with an insurance SOR. An application programming interface (API) or live access service may be updated (e.g., in real time) with matched Title SOR and Insurance SOR and update if those records are not matched. Various participants may use the API for various business purposes (e.g., broadcasting a message for a stolen or uninsured vehicle). In another embodiment, matches may be pending to wait for a trigger (e.g., brand new vehicles in queue pended to wait for DMV title). A VIN may be compared to auto manufacturer or dealership data to validate authenticity and hold in queue until DMV validates a new title. DMVs may update their systems such that this process may be real time, with minimal wait. In another embodiment, historical data streams may be used to troubleshoot and predict deviation and potential fraud. Analysis of risk factors may be executed proactively to determine potential fraud. Potential risk factors may include gaps in titling, a home address where a catastrophe occurred, large swings in sale prices, several state-to-state title transfers within a short timeframe, and such.

### Exemplary Vehicle

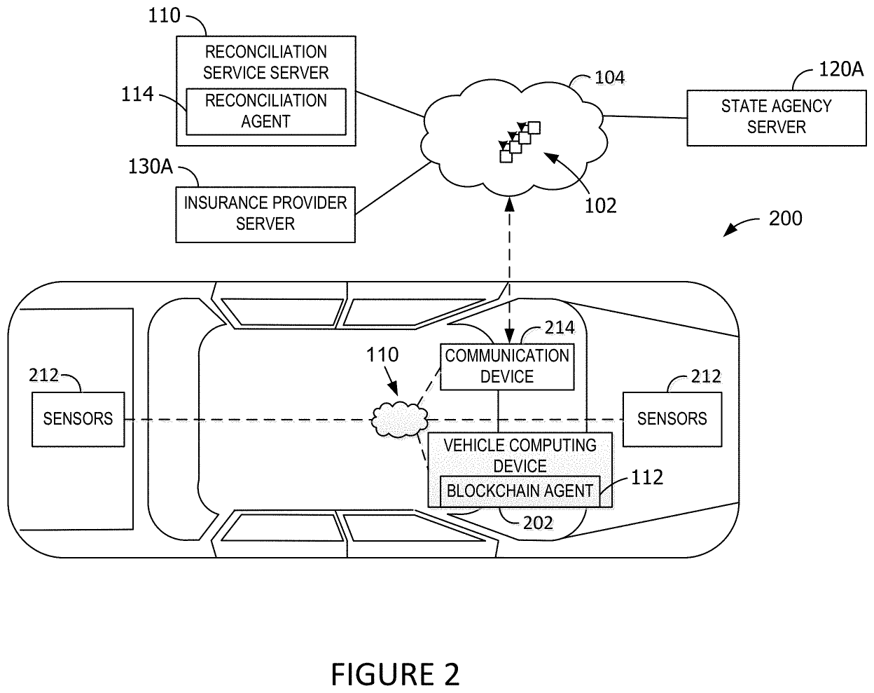

FIG. 2 depicts a view of an exemplary vehicle 200 that may participate in the blockchain system 100 shown in FIG. 1. In some embodiments, vehicle 200 may be an autonomous or semi-autonomous vehicle capable of fulfilling the transportation capabilities of a traditional automobile or other vehicle. In some embodiments, vehicle 200 may be capable of sensing its environment and navigating without human input. In other embodiments, vehicle 100 may be a manual vehicle, such as a traditional automobile that is controlled by a human driver 140. In some embodiments, vehicle 200 may be similar to smart vehicle 150.

Vehicle 200 may include a plurality of sensors 212 and a vehicle computing device 202 (e.g., a vehicle controller). The plurality of sensors 212 may detect the current surroundings and location of vehicle 200. Plurality of sensors 212 may include, but are not limited to, radar, LIDAR, Global Positioning System (GPS), video devices, imaging devices, cameras, audio recorders, and computer vision. Plurality of sensors 212 may also include sensors that detect conditions of vehicle 200, such as speed, acceleration, gear, braking, cornering, and other conditions related to the operation of vehicle 200, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 212 may include impact sensors that detect impacts to vehicle 200, including force and direction and sensors that detect actions of vehicle 200, such the deployment of airbags.

In the exemplary embodiment, vehicle computing device 202 may be configured with the blockchain agent 112, thereby allowing the vehicle 200 to participate in the P2P network 104 and the blockchain 102. The vehicle computing device 202 is in communication with a communication device 214 over an internal vehicle network 110 or other wired electronic communication coupling. The communication device 214 is configured to wirelessly communicate with P2P network 104 via, for example, a wireless cellular network or other wireless network (not separately shown).

In the exemplary embodiment, the vehicle computing device 202 may provide vehicle information (e.g., VIN, activity information) that may get added to the blockchain 102. For example, the vehicle computing device 202 may transmit vehicle information to the various participants in the P2P network 104 (e.g., reconciliation service server 110, insurance provider server 130A, or state agency server 120A), or add entry information directly to the blockchain 102 (e.g., via the blockchain agent 112).

In one embodiment, one of the participants in the P2P network 104 may query the vehicle 200, or the vehicle 200 may “register” with one of the participants, to determine or otherwise establish or confirm a VIN of the vehicle 200 (e.g., in an association with a particular policy 144 or a particular title 146). For example, the driver 140 may log onto a web server of the state agency 120A or the insurance provider 130A via the vehicle computing device 202, log into a personal account, and cause the vehicle computing device 202 to access and provide the VIN of the vehicle 200 to the state agency 120A or the insurance provider 130A. As such, the VIN is accurately provided to the participant, and thus will be more likely to be correctly uploaded into the blockchain 102 under the Policy or Title entry.

In some embodiments, the vehicle 200 may be a police car of a state or federal law enforcement agency being driven by a law enforcement officer. During a traffic stop of another vehicle (“subject vehicle”, not shown), the officer may perform a POI or a title validation of the driver 140 of the subject vehicle, or of the subject vehicle itself, using the blockchain 102. For example, the officer may identify the VIN of the subject vehicle and may enter the VIN and other driver information of the subject driver (e.g., from a driver's license, proof of registration card, or such) into the vehicle computing device 202 (e.g., via a graphical user interface). The vehicle computing device 202 may perform a search for a Policy or Title from the blockchain 102, as described above (e.g., updating New Policy or New Title entries with any matching Update-type entries), and perform the POI process described above to determine if the subject driver has a valid, active insurance policy 144, as well as a status check on the Title for the vehicle. Accordingly, using the blockchain 102, the officer is able to use the vehicle computing device 202 to satisfy POI and title check of the subject driver and vehicle during a traffic stop.

While vehicle 200 may be an automobile in the exemplary embodiment, in other embodiments, vehicle 200 may be, but is not limited to, other types of ground craft, aircraft, and watercraft vehicles.

### Exemplary Process for Adding and Updating a Policy in a Blockchain

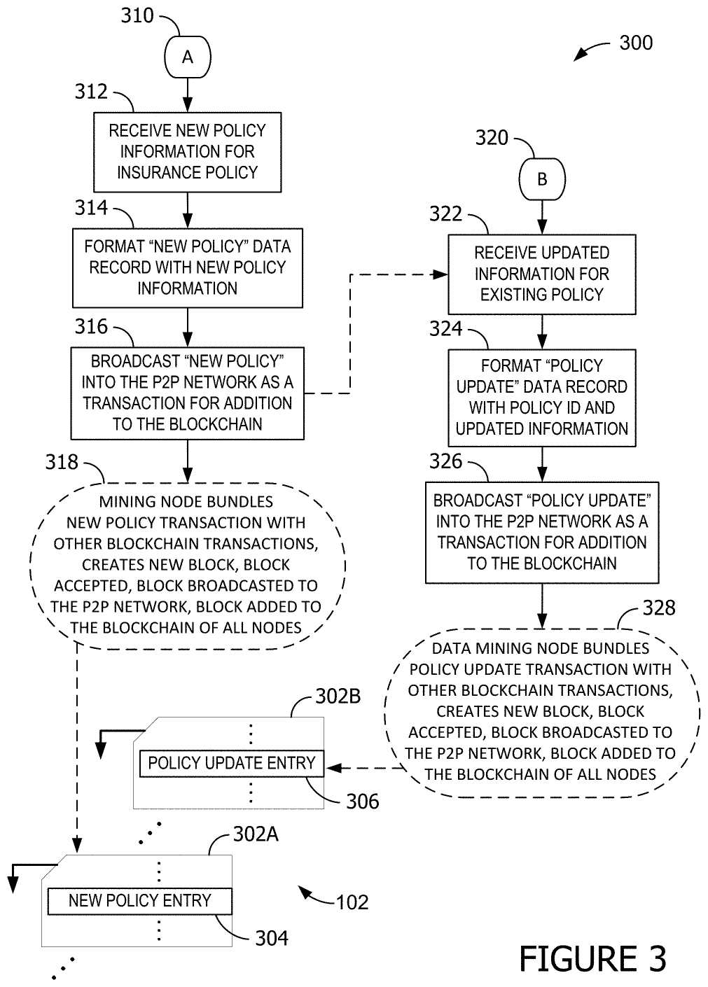

FIG. 3 illustrates a flow chart of an exemplary computer-implemented process 300 for adding and updating a policy in the blockchain 102 shown in FIG. 1. Process 300 may include two sub-processes. Process A 310 describes adding a new policy 144 to the blockchain 102 via a New Policy-type entry. Process B 320 describes updating the existing policy (e.g., the New Policy entry) via a Policy Update-type entry.

In the exemplary embodiment, the insurance provider 130A has formalized a new insurance policy 144 with the driver 140 (each shown in FIG. 1). The policy 144, in this example, is solely in the name of the driver 140 “Adam Smith”, who lives in the state of Illinois (IL). The policy 144 includes coverage for, inter alia, $20,000 property damage liability (the state minimum being $15,000 for this aspect) and $20,000 bodily injury per person per accident (the state minimum being $20,000 for this aspect). The policy 144 does not include any underinsured motorist coverage (the state requires a minimum of $20,000 coverage for this aspect). The policy 144 also identifies one vehicle for coverage, with a VIN of “ABC1234”, though the actual VIN for the vehicle is “ABCD1234”. Other policy data may also be included, but is left out of this example for purposes of brevity. This data is collectively referred to herein as the initial policy data.

FIG. 3 illustrates some steps of process 300 in solid line rectangles (e.g., steps 312, 314, and so forth, “solid line steps”) and other steps of process 300 in broken line rounded boxes (e.g., steps 318, 328, “broken line steps”). In the exemplary embodiment, the solid line steps are performed by insurance provider server 130A, which participates in the P2P network 104. Due to the distributed processing nature of blockchain and the underlying mechanics of adding transactions to the blockchain, the broken line steps may be performed by any or all of the data mining nodes within the P2P network (e.g., with the work of only one node being accepted as the “finalized” block to be added into the blockchain 102). Such steps begin, for example, when the receiving nodes within the P2P network 104 receive broadcasted transactions for addition to the blockchain 102. Accordingly, these steps are identified herein as being performed by “the mining node” for ease of explanation.

In the exemplary embodiment, the insurance provider server 130A receives 312 new policy information for a new insurance policy, such as policy 144. This initial policy data may be read or otherwise received from a database (not separately shown) of the insurance provider 130A. The insurance provider server 130A formats 314 a data record (not separately depicted) with data elements from the initial policy data. For example, the data record may be formatted to include data elements:
Entry_Type: 1 (New Policy)
Driver_Name: Adam Smith
State: IL
Policy_ID: 98765
VIN: ABC1234
Coverage_Property: $20,000
Coverage_Injury_Per_Person: $20,000
Coverage_Underinsured: $0

In the exemplary embodiment, the insurance provider server 130A broadcasts 316 this data record into the P2P network 104 as a New Policy-type transaction for addition to the blockchain 102. This broadcasted transaction is typically sent to all data mining nodes in the network 104. Each data mining node may bundle this transaction with other pending transactions and attempt to form a new block for entry into the blockchain 102.

In the exemplary embodiment, a mining node (not shown in FIG. 3) receives the New Policy transaction, bundles 318 this transaction with other pending transactions, and builds a block 302A for addition to the blockchain 102. This new transaction is included in the block as New Policy entry 304, which is one of several transactions within the new block 302A. The mining node may need to perform a conventional blockchain mining task of computing a hash value of the block 302A conforming to a particular format (e.g., starting with eight zeros). In this example, the mining node completes this task and is allowed to add the new block 302A to the blockchain 102. The new block 302A is broadcasted to the P2P network 104 and is added to the blockchain on all nodes within the network 104. Once added to the blockchain 102, the New Policy entry 304 is effectively memorialized in the blockchain 102 and is unchangeable.

In the exemplary embodiment, several issues are discovered with the initial policy data (and as memorialized in the New Policy entry 304). First, it is discovered that the VIN of the vehicle was incorrectly entered by the insurance provider. The VIN appearing in the New Policy entry 304 is “ABC1234”, but the correct VIN is “ABCD1234”. In addition, it is also discovered that the insurance policy as originally written (and as memorialized in the New Policy entry 304) does not include underinsured coverage that meets the state minimum for Illinois. The Underinsured_Coverage appearing in the New Policy entry is $0, but the state of Illinois requires at least $20,000. Process B 320 corrects these policy deficiencies in the blockchain 102.

In the exemplary embodiment, the insurance provider server 130A receives 322 updated information for the existing policy (e.g., for Policy_ID 98765). More specifically, the insurance provider server 130A receives a new VIN of “ABCD1234” and a new underinsured coverage amount of $20,000. The insurance provider server 130A formats 324 a data record (not separately depicted) with data elements that include the updated data. For example, the data record may be formatted to include data elements:
Entry_Type: 2 (Policy Update)
Policy_ID: 98765
VIN: ABCD1234
Coverage_Underinsured: $20,000

In some embodiments, the data record may also include a link data element that can include a transaction identifier that references other transactions in the blockchain 102 for this policy 144. When a transaction, such as the New Policy entry 304, is added to the blockchain 102, that transaction may be stamped with a unique transaction ID and timestamp information. When an Update-type entry is later added to the blockchain 102, the Update-type entry may include a transaction ID of the “parent” transaction (e.g., a transaction ID of the New Policy entry 304), or of the previous Update-type transaction for that policy 144. The link data element may be used to more easily access related entries in the blockchain 102 for the particular policy 144.

In the exemplary embodiment, the insurance provider server 130A broadcasts 326 this data record into the P2P network 104 as a Policy Update-type transaction for addition to the blockchain 102. This broadcasted transaction is sent to all data mining nodes in the network 104.

In the exemplary embodiment, the mining node receives the Policy Update transaction, bundles 328 this transaction with other pending transactions, and builds a block 302B for addition to the blockchain 102. This new transaction is included in the block as Policy Update entry 306, which is one of several transactions within the new block 302B. The mining node may need to perform a conventional blockchain mining task of computing a hash value of the block 302B conforming to a particular format (e.g., starting with eight zeros). In this example, the mining node completes this task and is allowed to add the new block 302B to the blockchain 102. The new block 302B is broadcasted to the P2P network 104 and is added to the blockchain on all nodes within the network 104. Once added to the blockchain 102, the Policy Update entry 306 is effectively memorialized in the blockchain 102 and may be used to “override” data elements in any preceding entry associated with that policy 144.

### Exemplary Process for Adding and Updating a Policy in a Blockchain

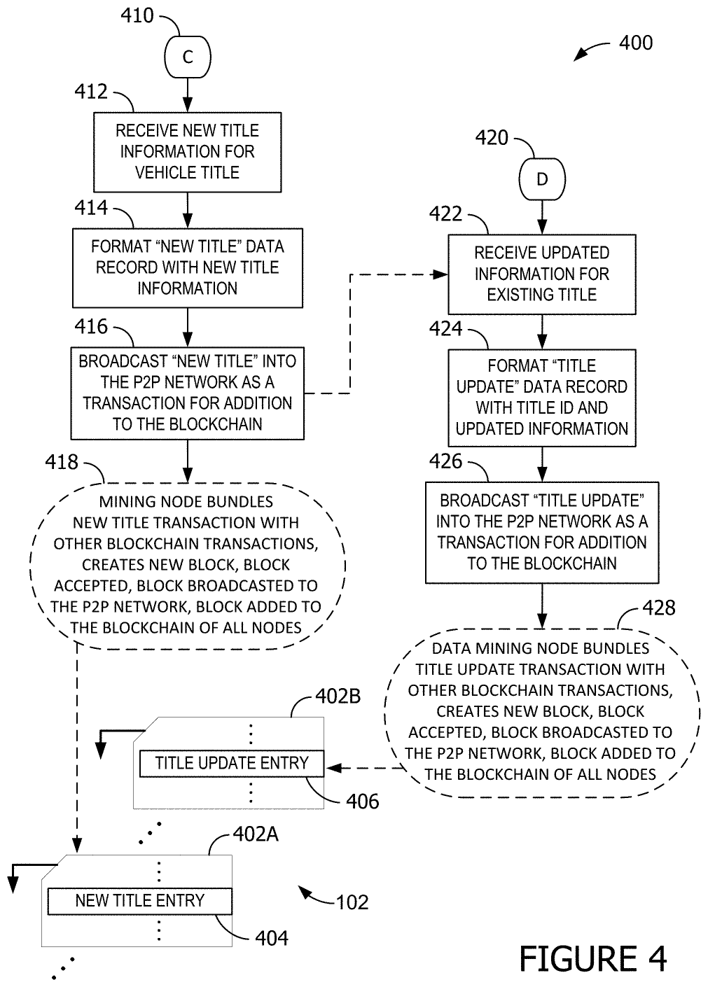

FIG. 4 illustrates a flow chart of an exemplary computer-implemented process 300 for adding and updating a title in the blockchain 102 shown in FIG. 1. Various steps in process 400 may be similar to corollary steps as describes with respect to process 300 of FIG. 3. In the exemplary embodiment, Process 400 may include two sub-processes. Process C 410 describes adding a new title 146 to the blockchain 102 via a New Title-type entry. Process D 420 describes updating an existing title (e.g., the New Title entry) via a Title Update-type entry.

In the exemplary embodiment, the state agency 120A has formalized a new title 146 for the vehicle covered by the example policy described in FIG. 3. The title 146, in this example, is issued by the state of Illinois, and solely in the name of the driver 140 “Adam Smith”. The title 146 includes a title identifier of “IL54321” and a current title status of “active”. The title 146 also identifies a vehicle VIN of “ABCD1234”, a year of the vehicle of 1999, a vehicle make of “Ford”, and a vehicle model of “F250”. Other title data may also be included, but is left out of this example for purposes of brevity. This data is collectively referred to herein as the initial title data.

FIG. 4 illustrates some steps of process 400 in solid line rectangles (e.g., steps 412, 414, and so forth, “solid line steps”) and other steps of process 400 in broken line rounded boxes (e.g., steps 418, 428, “broken line steps”). In the exemplary embodiment, the solid line steps are performed by state agency server 120A, which participates in the P2P network 104. Due to the distributed processing nature of blockchain and the underlying mechanics of adding transactions to the blockchain, the broken line steps may be performed by any or all of the data mining nodes within the P2P network (e.g., with the work of only one node being accepted as the “finalized” block to be added into the blockchain 102). Such steps begin, for example, when the receiving nodes within the P2P network 104 receive broadcasted transactions for addition to the blockchain 102. Accordingly, these steps are identified herein as being performed by “the mining node” for ease of explanation.

In the exemplary embodiment, the state agency server 120A receives 412 new title information for a new vehicle title, such as title 146. This initial title data may be read or otherwise received from a database (not separately shown) of the state agency 120A. The state agency server 120A formats 414 a data record (not separately depicted) with data elements from the initial title data. For example, the data record may be formatted to include data elements:
Entry_Type: 3 (New Title)
Driver_Name: Adam Smith
State: IL
Title_ID: IL54321
Title_Status: 0 (Active)
VIN: ABCD1234
Year: 1999
Make: Ford
Model: F250

In the exemplary embodiment, the state agency server 120A broadcasts 416 this data record into the P2P network 104 as a New Title-type transaction for addition to the blockchain 102. This broadcasted transaction is typically sent to all data mining nodes in the network 104. Each data mining node may bundle this transaction with other pending transactions and attempt to form a new block for entry into the blockchain 102.

In the exemplary embodiment, a mining node (not shown in FIG. 4) receives the New Title transaction, bundles 418 this transaction with other pending transactions, and builds a block 402A for addition to the blockchain 102. This new transaction is included in the block as New Title entry 404, which is one of several transactions within the new block 402A. The mining node may need to perform a conventional blockchain mining task of computing a hash value of the block 402A conforming to a particular format (e.g., starting with eight zeros). In this example, the mining node completes this task and is allowed to add the new block 402A to the blockchain 102. The new block 402A is broadcasted to the P2P network 104 and is added to the blockchain on all nodes within the network 104. Once added to the blockchain 102, the New Title entry 404 is effectively memorialized in the blockchain 102 and is unchangeable.

In the exemplary embodiment, an accident occurs with the vehicle, and the vehicle is totaled in the accident (e.g., as assessed by the insurance provider 130A). Process D 420 updates the title 146 in the blockchain 102 to reflect a change in status.

In the exemplary embodiment, the state agency server 120A receives 422 updated information for the existing title (e.g., for Title_ID IL54321). More specifically, the state agency server 120A receives a new status of “1” (Salvage). The state agency server 120A formats 424 a data record (not separately depicted) with data elements that include the updated data. For example, the data record may be formatted to include data elements:
Entry_Type: 4 (Title Update)
Title_ID: IL54321
Title_Status: 1 (Salvage)

In some embodiments, the data record may also include a link data element that can include a transaction identifier that references other transactions in the blockchain 102 for this title 146. When a transaction, such as the New Title entry 404, is added to the blockchain 102, that transaction may be stamped with a unique transaction ID and timestamp information. When an Update-type entry is later added to the blockchain 102, the Update-type entry may include a transaction ID of the “parent” transaction (e.g., a transaction ID of the New Title entry 304), or of the previous Update-type transaction for that title 146. The link data element may be used to more easily access related entries in the blockchain 102 for the particular title 146.

In the exemplary embodiment, the state agency server 120A broadcasts 426 this data record into the P2P network 104 as a Title Update-type transaction for addition to the blockchain 102. This broadcasted transaction is sent to all data mining nodes in the network 104.

In the exemplary embodiment, the mining node receives the Title Update transaction, bundles 328 this transaction with other pending transactions, and builds a block 402B for addition to the blockchain 102. This new transaction is included in the block 402B as Title Update entry 406, which is one of several transactions within the new block 402B. The mining node may need to perform a conventional blockchain mining task of computing a hash value of the block 402B conforming to a particular format (e.g., starting with eight zeros). In this example, the mining node completes this task and is allowed to add the new block 402B to the blockchain 102. The new block 402B is broadcasted to the P2P network 104 and is added to the blockchain on all nodes within the network 104. Once added to the blockchain 102, the Title Update entry 406 is effectively memorialized in the blockchain 102 and may be used to “override” data elements in any preceding entry associated with that title 146.

### Exemplary Computer-Implemented Method for Performing Proof of Insurance in a Blockchain

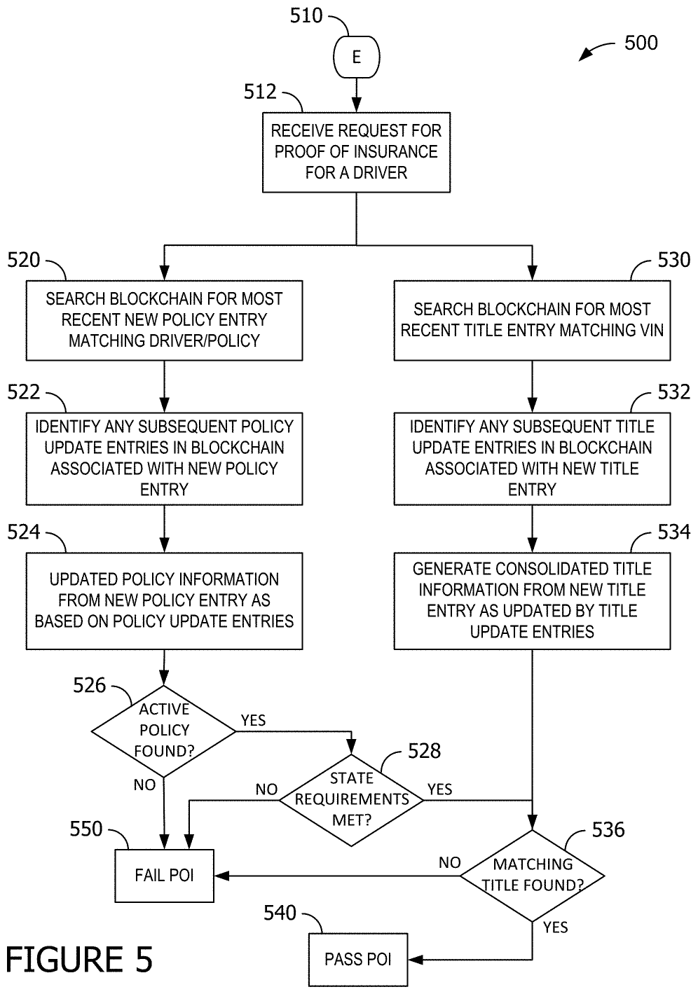

FIG. 5 illustrates a flow chart of an exemplary computer-implemented method (“POI process”) 500 for performing proof of insurance of a driver 140 and associated vehicle in the blockchain 102 shown in FIG. 1. In the exemplary embodiment, process 500 is performed by a state agency computing device such as state agency server 120A. For example, the driver 140 may be at their local DMV attempting to renew license plates for their vehicle, at which time the state requires POI. In another example embodiment, process 500 may be performed by a smart vehicle such as shown in FIG. 2. For example, a law enforcement official may be conducting a traffic stop of the driver and the vehicle, at which time the officer conducts the POI process 500. In this example, it is presumed that the New Policy entry 304 and the Policy Update entry 306 of FIG. 3 are entered into the blockchain 102, as well as the New Title entry 404 of FIG. 4, but not the Title Update entry 406 (e.g., as the vehicle has not yet been totaled).

In the exemplary embodiment, the state agency server 120A receives 512 a request for proof of insurance for the driver 140. The request may include, for example, the Policy_ID (e.g., as provided by the driver 140 from an insurance card). In other embodiments, the request may include alternative or additional search criteria, such as driver identification information (e.g., name, address, state driver's license number) or VIN of the vehicle. Such information may be used as search criteria in the following steps.

In the exemplary embodiment, the state agency server 120A performs two branches of examination, using the search criteria to examine the blockchain 102 for both insurance policy information and title information associated with the vehicle and driver 140. More specifically, the state agency server 120A searches 520 the blockchain 102 for the most recent New Policy-type entry that matches the chosen search criteria. For example, the state agency server 120A may inspect all transactions in each block starting at the most recent block in the blockchain 102. The search concludes when the first New Policy transaction matching the search criteria is found (e.g., New Policy entry 304, being the most recent New Policy entry for this VIN). If no New Policy entry is identified for the given search criteria, then the POI process 500 finds no active policy (e.g., at test 526) and the POI fails 550.

In the exemplary embodiment, the state agency server 120A also searches 522 for any Policy Update-type entries for this search. In some embodiments, the same search criteria for search 520 may be used for search 522. In the exemplary embodiment, the search criteria used for search 522 may be using data derived from the New Policy entry. For example, after finding the New Policy entry 304 (e.g., with whatever search criteria), the state agency server 120A may extract the Policy_ID and timestamp value from the New Policy entry 304. The state agency server 120A may then use that Policy_ID and the timestamp from the New Policy entry 304 to identify subsequent Policy Update-type entries for that Policy_ID. As such, in this example, the state agency server 120A extracts Policy_ID “98765” and searches the blockchain 102 with that Policy_ID to identify Policy Update entry 306.

In other embodiments, search 520 may include searching the blockchain 102 for the most recent Policy-type entry (e.g., New Policy-type entry or Policy Update-type entry) that matches the search criteria. For example, starting with the most recent block (e.g., the most recent transactions to be added to the blockchain 102), the state agency server 120A may locate the Policy Update entry 306 first. Accordingly, the state agency server 120A may extract link information from the Policy Update entry 306, which provides a transaction identifier for another associated Policy-type entry associated with the Policy Update entry 306. In this example, the Policy Update entry 306 includes a transaction ID of the New Policy entry 304. As such, the state agency server 120A uses the transaction ID provided in the link data element as search criteria, searching the blockchain 102 for that specific transaction. If the found transaction is another Policy Update-type entry, then that Policy Update entry is also included in the search results, and the state agency server 120A continues tracking links by again extracting a transaction ID from this Policy Update entry and searching for that transaction ID in the blockchain 102. Eventually, this link tracking will lead to the New Policy entry 304 for the policy 144, at which point the searches 520, 522 are complete.

In the exemplary embodiment, the state agency server 120A uses the identified New Policy entry 304 and any identified Policy Update entries (e.g., Policy Update entry 306) to update 524 policy information for the policy 144. For example, the state agency server 120A may use all of the data elements provided in the New Policy entry 304 as the initial policy data for the policy 144, and may then update the policy data based upon each of the identified Policy Update entries, in order of their timestamp information. The state agency server 120A may, for example, update the previous value of a data element with a data value provided in the next Policy Update entry. For example, the initial value of the data element “VIN” is “ABC1234” (e.g., as provided in the New Policy entry 304). Upon processing the Policy Update entry 306, since the Policy Update entry 306 includes the data element “VIN”, the state agency server 120A overwrites the original VIN with the new value of “ABCD1234”. Similarly, the state agency server 120A may identify an initial value of Coverage_Underinsured as $0 (e.g., as provided in the New Policy entry 304), or perhaps the Coverage_Underinsured entry did not occur at all in the New Policy entry 304. Upon processing the Policy Update entry 304, since the Policy Update entry 306 includes the data element “Coverage_Underinsured”, the state agency server 120A overwrites (or creates) the Coverage_Underinsured data element with the value $20,000. As such, the updated 524 policy information now reflects the most up to date information on the policy 144, as memorialized in the blockchain 102.

In the exemplary embodiment, the state agency server 120A tests 526 to see if an active policy is found. In some embodiments, an active policy is not found if the searches 520, 522 locate no New Policy entry matching the search criteria. In some embodiments, if a New Policy entry 304 is found, then the state agency server 120A may examine the updated policy information to determine whether test 526 passes or fails. For example, the state agency server 120A may examine a “Policy_Status” data element to determine whether the policy is currently active, cancelled, expired, or such. If the policy status check fails, then test 526 fails. For another example, the state agency server 120A may compare a date range of coverage of the policy 144 to the present date to determine if the policy is currently active. If the date check fails, then test 526 fails. As such, if no active policy is found at test 526, then the state agency server fails 550 the POI process 500 for the driver 140.

In the exemplary embodiment, if an active policy is found at test 526, then the state agency server 120A tests 528 the policy data to determine if the policy 144 meets state requirements. For example, the state agency server 120A may compare coverage amounts to a table of known coverage minimums for the identified state. If any of the coverage minimums are not met, then test 528 fails, and the state agency server fails 550 the POI process 500 for the driver 140.

In the exemplary embodiment, if all state requirements are met at test 528, then the state agency server 120A searches for a title 146 of the vehicle within the blockchain 102. More specifically, and similar to the process for searching the blockchain 102 for policy information, the state agency server 120A searches 530 the blockchain 102 for the most recent New Title entry matching the subject VIN (e.g., New Title entry 404). In addition, the state agency server 120A identifies 532 any subsequent Title Update-type entries in the blockchain 102 that are associated with the New Title entry 404. In this example, no Title Update-type entries have yet been added to the blockchain, so the updated title information is merely the original title information memorialized in the New Title entry 404.

In the exemplary embodiment, the state agency server 120A tests 536 to see if a matching title 146 is found for the subject policy 144. For example, the state agency server 120A may compare the VIN of the New Title record 404 to the VIN identified in the updated policy information. If the two VINs do not match, then the state agency server 120A may fail test 536, and the POI process 500 fails 550 for the driver 140. If the test 536 succeeds, then the state agency server 120A passes 540 the POI process 500 for the driver 140.

### Exemplary Server Device

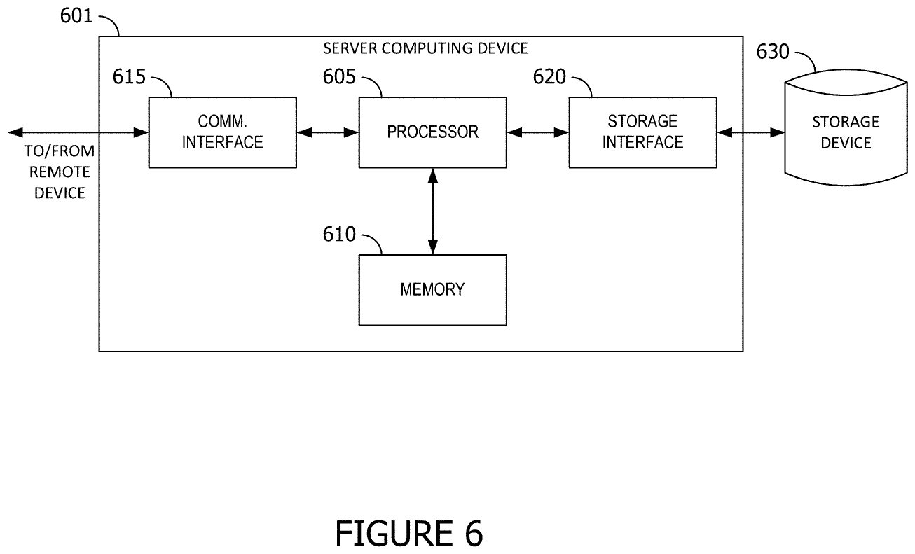

FIG. 6 depicts an exemplary configuration of server computing device 601. Server device 601 may include, but is not limited to, state agency servers 120, insurance provider servers 130, or the reconciliation service server 110 shown in FIG. 1. Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, state agency servers 120, insurance provider servers 130, or the reconciliation service server 110, or any computing device otherwise participating in P2P network 104 (shown in FIG. 1). For example, communication interface 615 may receive transaction broadcasts or blockchain updates from other nodes in the P2P network 104.

Processor 605 may also be operatively coupled to a storage device 630. Storage device 630 may be any computer-operated hardware suitable for storing and/or retrieving data, such as, but not limited to, data associated with a database. In some embodiments, storage device 630 may be integrated in server computer device 601. For example, server computer device 601 may include one or more hard disk drives as storage device 630.

In other embodiments, storage device 630 may be external to server computer device 601 and may be accessed by a plurality of server computer devices 601. For example, storage device 630 may include a storage area network (SAN), a network attached storage (NAS) system, and/or multiple storage units such as hard disks and/or solid state disks in a redundant array of inexpensive disks (RAID) configuration.

In some embodiments, processor 605 may be operatively coupled to storage device 630 via a storage interface 620. Storage interface 620 may be any component capable of providing processor 605 with access to storage device 630. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 630.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 3-5.

### Exemplary Client Device

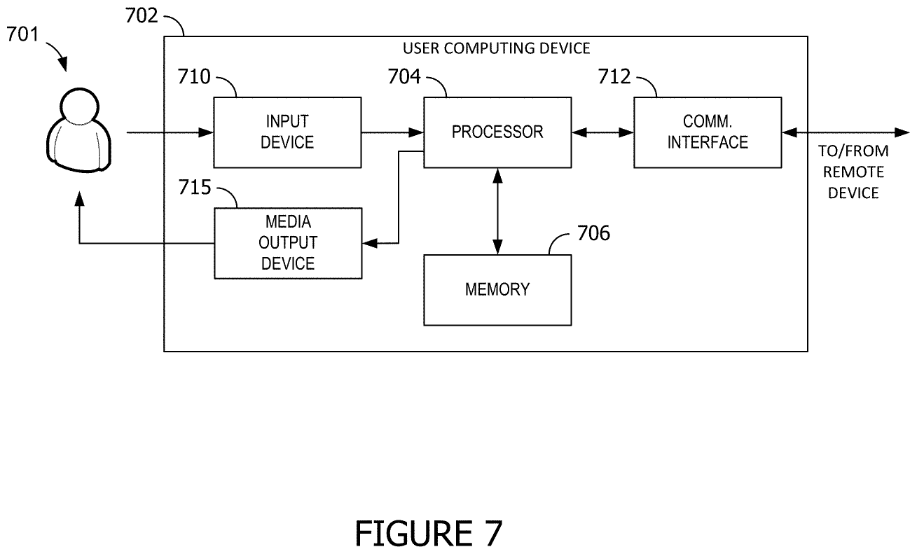

FIG. 7 depicts an exemplary configuration of user computer device 702, in accordance with one embodiment of the present disclosure. User computer device 702 may be operated by a user 701. User computer device 702 may include, but is not limited to, personal computer devices 142 (shown in FIG. 1), vehicle computing devices 410 (shown in FIG. 2), and mobile devices of the driver 140. User computer device 702 may include a processor 704 for executing instructions. In some embodiments, executable instructions may be stored in a memory area 706. Processor 704 may include one or more processing units (e.g., in a multi-core configuration). Memory area 706 may be any device allowing information such as executable instructions and/or transaction data to be stored and retrieved. Memory area 706 may include one or more computer readable media.

User computer device 702 may also include at least one media output component 715 for presenting information to user 701. Media output component 715 may be any component capable of conveying information to user 701. In some embodiments, media output component 715 may include an output adapter (not shown) such as a video adapter and/or an audio adapter. An output adapter may be operatively coupled to processor 704 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 715 may be configured to present a graphical user interface (e.g., a web browser and/or a client application) to user 701. A graphical user interface may include, for example, an online store interface for viewing and/or purchasing items, and/or a wallet application for managing payment information. In some embodiments, user computer device 702 may include an input device 710 for receiving input from user 701. User 701 may use input device 710 to, without limitation, select and/or enter policy information or search criteria for searching the blockchain 102 (shown in FIG. 1).

Input device 710 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 710.

User computer device 702 may also include a communication interface 712, communicatively coupled to a remote device such as state agency servers 120, insurance provider servers 130, or the reconciliation service server 110 shown in FIG. 1. Communication interface 712 may include, for example, a wired or wireless network adapter and/or a wireless data transceiver for use with a mobile telecommunications network.

Stored in memory area 706 are, for example, computer readable instructions for providing a user interface to user 701 via media output component 715 and, optionally, receiving and processing input from input device 710. A user interface may include, among other possibilities, a web browser and/or a client application. Web browsers enable users, such as user 701, to display and interact with media and other information typically embedded on a web page or a web site. A client application may allow user 701 to interact with, for example, the blockchain 102. For example, instructions may be stored by a cloud service, and the output of the execution of the instructions sent to the media output component 715.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, autonomous vehicle, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the mobile device, driver, and/or vehicle from device details, mobile device sensors, geolocation information, image data, and/or other data.

Based upon these analyses, the processing element may learn how to identify characteristics and patterns that may then be applied to analyzing sensor data, authentication data, image data, mobile device data, and/or other data. For example, the processing element may learn, with the user's permission or affirmative consent, to identify the type of trip that is planned based upon minimal information or despite a misclassification by a user. The processing element may also learn how to identify different types of routes and/or driver behaviors based upon differences in the received sensor data.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer system for providing data validation using a blockchain, the computer system including at least one processor in communication with at least one memory device, the at least one processor programmed to:
receive a registration request for a driver and a vehicle, the registration request generated based at least in part upon an input received at a graphical user interface (GUI) of a third party device in communication with the blockchain, wherein the input includes a driver identifier and a vehicle identifier, and wherein the registration request includes the driver identifier, the vehicle identifier, and a request for title data for the vehicle in a geographic location;
perform a look-up within the blockchain using the driver identifier and the vehicle identifier to retrieve (i) title data including a most recent title entry associated with the vehicle and (ii) a most recent policy entry associated with one or more of the driver and the vehicle, the blockchain includes a plurality of validated policy entries associated with vehicle insurance policies and a plurality of validated title entries associated with state property titles;
determine, based upon the look-up, that the retrieved title entry and the retrieved policy entry are associated with the driver identifier and the vehicle identifier of the registration request;
verify the registration request in response to determining that the driver and the vehicle of the registration request are associated with a valid title for the geographic location and a valid insurance policy; and
transmit a registration response message to the third party device confirming the verification.

2. The computer system of claim 1, wherein the processor is further programmed to update policy information from a new policy entry based upon one or more policy update entries in the blockchain associated with the new policy entry.

3. The computer system of claim 2, wherein updating policy information from the new policy entry further includes overwriting one or more data elements of the policy information with one or more corresponding data elements included in a policy update entry having a more recent timestamp than the one or more data elements.

4. The computer system of claim 2, wherein the processor is further programmed to search the blockchain for the one or more policy update entries subsequent to the new policy entry, including comparing timestamp information of the new policy entry to timestamp information contained within the one or more policy update entries.

5. The computer system of claim 1, wherein the processor is further configured to determine whether the vehicle has a valid title by searching the blockchain for the most recent title entry for the vehicle.

6. The computer system of claim 5, wherein searching the blockchain for the most recent title entry for the vehicle includes searching the blockchain for the most recent title entry that includes a vehicle identification number (VIN) matching a VIN associated with the retrieved policy entry.

7. The computer system of claim 1, wherein the processor is further configured to compare one or more policy data elements to one or more state requirements for vehicle insurance to determine that all of the one or more state requirements for vehicle insurance are met by an active policy.

8. The computer system of claim 1, wherein searching the blockchain for the most recent policy entry associated with one or more of the driver and the vehicle includes searching the blockchain for the most recent policy entry having a vehicle identification number (VIN) matching the vehicle.

9. The computer system of claim 1, wherein the processor is further configured to:
receive a request to add a new policy to the blockchain;
create a new policy data record including a plurality of data elements representing aspects of the new policy; and
broadcast, to a peer-to-peer (P2P) network associated with the blockchain, the new policy data record as a new transaction to be added to the blockchain, the new transaction becomes the most recent policy entry once added to the blockchain.

10. A computer-implemented method for providing data validation using a blockchain, the method implemented on a computer system including at least one processor in communication with at least one memory device, the method comprising:
receiving a registration request for a driver and a vehicle, the registration request generated based at least in part upon an input received at a graphical user interface (GUI) of a third party device in communication with the blockchain, wherein the input includes a driver identifier and a vehicle identifier, and wherein the registration request includes the driver identifier, the vehicle identifier, and a request for title data for the vehicle in a geographic location;
performing a look-up within the blockchain using the driver identifier and the vehicle identifier to retrieve (i) title data including a most recent title entry associated with the vehicle and (ii) a most recent policy entry associated with one or more of the driver and the vehicle, the blockchain includes a plurality of validated policy entries associated with vehicle insurance policies and a plurality of validated title entries associated with state property titles;
determining, based upon the look-up, that the retrieved title entry and the retrieved policy entry are associated with the driver identifier and the vehicle identifier of the registration request;
verifying the registration request in response determining that the driver and the vehicle of the registration request are associated with a valid title for the geographic location and a valid insurance policy; and
transmitting a registration response message to the third party device confirming the verification.

11. The method of claim 10 further comprising updating policy information from a new policy entry based upon one or more policy update entries in the blockchain associated with the new policy entry.

12. The method of claim 11, wherein updating policy information from the new policy entry further includes overwriting one or more data elements of the policy information with one or more corresponding data elements included in a policy update entry having a more recent timestamp than the one or more data elements.

13. The method of claim 11 further comprising searching the blockchain for the one or more policy update entries subsequent to the new policy entry, including comparing timestamp information of the new policy entry to timestamp information contained within the one or more policy update entries.

14. The method of claim 10 further comprising determining whether the vehicle has a valid title by searching the blockchain for the most recent title entry for the vehicle.

15. The method of claim 14, wherein searching the blockchain for the most recent title entry for the vehicle includes searching the blockchain for the most recent title entry that includes a vehicle identification number (VIN) matching a VIN associated with the retrieved policy entry.

16. The method of claim 10 further comprising comparing one or more policy data elements to one or more state requirements for vehicle insurance to determine that all of the one or more state requirements for vehicle insurance are met by an active policy.

17. The method of claim 10, wherein searching the blockchain for the most recent policy entry associated with one or more of the driver and the vehicle includes searching the blockchain for the most recent policy entry having a vehicle identification number (VIN) matching the vehicle.

18. The method of claim 10 further comprising:
receiving a request to add a new policy to the blockchain;
creating a new policy data record including a plurality of data elements representing aspects of the new policy; and
broadcasting, to a peer-to-peer (P2P) network associated with the blockchain, the new policy data record as a new transaction to be added to the blockchain, the new transaction becoming the most recent policy entry once added to the blockchain.

19. At least one non-transitory computer-readable storage media having computer-executable instructions embodied thereon, wherein when executed by at least one processor, the computer-executable instructions cause the processor to:
receive a registration request for a driver and a vehicle, the registration request generated based at least in part upon an input received at a graphical user interface (GUI) of a third party device in communication with the blockchain, wherein the input includes a driver identifier and a vehicle identifier, and wherein the registration request includes the driver identifier, the vehicle identifier, and a request for title data for the vehicle in a geographic location;
perform a look-up within a blockchain using the driver identifier and the vehicle identifier to retrieve (i) title data including a most recent title entry associated with the vehicle and (ii) a most recent policy entry associated with one or more of the driver and the vehicle, the blockchain includes a plurality of validated policy entries associated with vehicle insurance policies and a plurality of validated title entries associated with state property titles;
determine, based upon the look-up, that the retrieved title entry and the retrieved policy entry are associated with the driver identifier and the vehicle identifier of the registration request;
verify the registration request in response to determining that the driver and the vehicle of the registration request are associated with a valid title for the geographic location and a valid insurance policy; and
transmit a registration response message to the third party device confirming the verification.

20. The computer-readable storage media of claim 19, wherein the computer-executable instructions further cause the processor to update policy information from a new policy entry based upon one or more policy update entries in the blockchain associated with the new policy entry.

21. The computer-readable storage media of claim 20, wherein updating policy information from the new policy entry further includes overwriting one or more data elements of the policy information with one or more corresponding data elements included in a policy update entry having a more recent timestamp than the one or more data elements.

22. The computer-readable storage media of claim 20, wherein the computer-executable instructions further cause the processor to search the blockchain for the one or more policy update entries subsequent to the new policy entry, including comparing timestamp information of the new policy entry to timestamp information contained within the one or more policy update entries.

23. The computer-readable storage media of claim 19, wherein the computer-executable instructions further cause the processor to determine whether the vehicle has a valid title by searching the blockchain for the most recent title entry for the vehicle.

24. The computer-readable storage media of claim 23, wherein searching the blockchain for the most recent title entry for the vehicle includes searching the blockchain for the most recent title entry that includes a vehicle identification number (VIN) matching a VIN associated with the retrieved policy entry.

25. The computer-readable storage media of claim 19, wherein the computer-executable instructions further cause the processor to compare one or more policy data elements to one or more state requirements for vehicle insurance to determine that all of the one or more state requirements for vehicle insurance are met by an active policy.

26. The computer-readable storage media of claim 19, wherein searching the blockchain for the most recent policy entry associated with one or more of the driver and the vehicle includes searching the blockchain for the most recent policy entry having a vehicle identification number (VIN) matching the vehicle.

27. The computer-readable storage media of claim 19, wherein the computer-executable instructions further cause the processor to:
receive a request to add a new policy to the blockchain;
create a new policy data record including a plurality of data elements representing aspects of the new policy; and
broadcast, to a peer-to-peer (P2P) network associated with the blockchain, the new policy data record as a new transaction to be added to the blockchain, the new transaction becomes the most recent policy entry once added to the blockchain.
